(19) United States
(12) Patent Application Publication
(10) Pub. No.: US 2022/0196847 A1
(43) Pub. Date: Jun. 23, 2022

(54) TRACER ASSOCIATED WITH A ROAMING ENTITY AND COMMUNICATION METHOD BETWEEN A SYSTEM FOR SUPERVISING THE GEOGRAPHICAL POSITION OF THE ENTITY AND SAID TRACER

(71) Applicant: Alfred RICHARD, 8 Rue Therese (FR)

(72) Inventor: Alfred RICHARD, 8 Rue Therese (FR)

(21) Appl. No.: 17/599,476

(22) PCT Filed: Mar. 30, 2020
(86) PCT No.: PCT/EP2020/058978

§ 371 Date: Mar. 8, 2022

(30) Foreign Application Priority Data
Mar. 28, 2019 (FR) 1903260

(51) Int. Cl. G01S 19/26; G08B 21/22; G01S 19/48

(52) U.S. Cl. CPC G01S 19/26; G01S 19/48; G08B 21/22

(57) ABSTRACT

The invention concerns a method of communication between a monitoring system (61) monitoring a roaming entity and an electronic communication tracking device (TR) linked to the roaming entity. The method includes the following steps:
obtaining the current geographical position of the tracker (TR) by indirect geolocation and transmit this to the monitoring system (61);
comparing the current geographical position that has been obtained with cartographic data of areas associated with restricted communication,
in the event of a match, stopping indirect geolocation;
measuring and recording at least one of the tracker's (TR) environmental factors in order to determine an environmental change relating to the end of roaming within the area of restricted communication;
starting satellite geolocation and comparing the position that has been obtained with cartographic data of areas associated with authorized communication, if an environmental change is determined relating to the end of roaming; and
restarting indirect geolocation if there is a match.

This invention concerns an electronic communication tracking device designed to be linked to a roaming entity and a communication method between a system monitoring the geographical position of the entity and the aforementioned tracker.

It is generally to be used when the entity that is to be tracked is following a route that includes one or more areas associated with restricted or prohibited communication, and, more particularly, when the entity's route includes an air flight, on which certain international air law regulations prohibit all electronic communications during the aircraft's take-off and landing phases.

It is known that existing geolocation devices, as well as their associated processes, already make it possible for an object or person to be located while taking into account areas of restricted communication.

The device described in document JP 2002 359682 A is also known. This device makes possible a hybrid form of GPS and cellular geolocation but does not allow the environment nor any restricted areas that the roaming entity may move through to be taken into account.

However, current geolocation devices are expensive, often complex and require information to be exchanged frequently across multiple sources. Moreover, these geolocation devices are often not very autonomous and require high energy consumption for optimal functioning.

In this patent, the term “entity” refers to any object, person, container or commodity which is to be tracked, and, in particular, the geographical position of the entity.

The term “area associated with restricted or prohibited communication” refers to certain areas located in airports, hospitals, ports or customs areas, open sea, military areas and private restricted areas, within which electronic communications are restricted or even prohibited. These particular areas may be defined in specific regulations (air law, maritime law, military law, customs law, and the like).

The term “roaming” refers to any movement of the entity by aircraft, ship, train, land vehicles and the like.

The Applicant has faced the problem of providing a tracker linked to a roaming entity, capable of activating/deactivating its electronic communication according to the areas which are being moved through, depending on whether they are areas associated with restricted or prohibited communication or not, so as to comply with the regulations specific to each of the areas associated with restricted/prohibited communication.

This invention provides a solution to this very problem while overcoming the disadvantages of previous forms of geolocation devices.

Thus, this invention concerns an electronic communication tracking device designed to be linked to a roaming entity in order to obtain its geolocation, in particular, when this entity follows a route which includes one or more areas associated with restricted or prohibited communication.

This invention concerns an electronic communication tracking device designed to be linked to a roaming entity, and includes:
a processing unit;
a data memory including cartographic data of areas associated with restricted or prohibited communication and cartographic data of areas associated with authorized communication;
communication means which ensure that, when in active mode, the aforementioned tracker can be indirectly geolocated by detecting network elements and by searching an online databased including the locating of network elements, and which ensure that the geolocation is transmitted to a system monitoring the roaming entity;
sensor means capable of continuously receiving at least one of the tracker's environmental factors in order to indicate an environmental change around said tracker which relates to the end of the entity's roaming within an area of restricted communication; and
satellite geolocation means to ensure, when in active mode, direct geolocation communication in order to receive a satellite geographical position;

According to a general definition of the invention, the processing unit is able to compare the current geographical position that has been obtained by indirect geolocation with built-in cartographic data of areas associated with restricted communication, and, if there is a match, the processing unit is able to deactivate the communication means as well as the satellite geolocation means, and the processing unit is, in addition to this, after having determined an environmental change of the tracker which relates to the end of roaming, able to activate the satellite geolocation means in order to receive the satellite geographical position of the tracker and to compare this with the cartographic data of areas of authorized communication, and if there is a match, to reactivate the communication means in order to indirectly geolocate the tracker.

According to an embodiment of the invention, after the entity has stopped roaming within an area of restricted communication, the processing unit is able to activate the satellite geolocation means in order to receive the satellite geographical position of the device and to compare it with the cartographic data of areas of authorized communication, and if there is a match, to reactivate the communication means while deactivating the satellite geolocation means.

According to another embodiment of the invention, the communication means are able to detect network elements distributed within the areas of authorized communication and to search an online database in order to indirectly obtain the geolocation linked to the connected elements that have been detected, and to report the positions that have been determined on an online cartographic platform in order to obtain the current geographical position of the tracker by indirect geolocation.

The device, in accordance with the invention, also includes a supply source.

The sensor means of the aforementioned tracker, in accordance with the invention, form a group consisting of: a chronometer, an altimeter, an accelerometer, a photometer, a compass, and a thermometer.

In practice, the device's processing unit, according to the invention, is able to:
search an online database, including all information relating to airport flights, such as identifiers and locations of boarding gates, relevant check-in gates, geographical airport data, destination and estimated flight time for each flight;
compare the last geographical position obtained by the communication means before movement into an area of restricted communication with the geographical airport data in the aforementioned database;
determine the flight in which the entity is roaming on the basis of the last position that was established before movement into an area of restricted communication and on the basis of information in the online database that has been searched;
download, after having determined the flight linked to the roaming entity, the information relating to the flight that has previously been determined.

According to a first particular embodiment of the invention, the processing unit is able to:
compare the time that has elapsed since switching to offline mode and activating the satellite geolocation means with the expected theoretical duration of roaming calculated from the data downloaded before activating offline mode;
prevent activation of the satellite geolocation means and keep the device in offline mode, if the time that has elapsed since activating offline mode is less than the expected theoretical duration.

According to a second particular embodiment of the invention, the processing unit is able to:
compare the time that has elapsed since switching to offline mode and activating the satellite geolocation means with the expected theoretical duration of roaming calculated from the data downloaded before activating offline mode,
enable activation of the satellite geolocation means, if the time that has elapsed since activating offline mode is consistent with the expected theoretical duration.

This invention also concerns a communication method between a system monitoring the roaming entity and an electronic communication tracking device linked to the aforementioned roaming entity, characterized by the following steps:
obtain the current geographical position of the tracker by indirect geolocation by detecting surrounding network elements and searching an online database referencing each geographical position linked to the network elements that have been detected by the communication means, and transmitting this to the monitoring system;
compare the current geographical position that has been obtained with cartographic data of areas associated with restricted communication,
stop indirect geolocation if there is a match;
measure and record at least one of the tracker's environmental factors in order to determine an environmental change which relates to the end of roaming within the area of restricted communication;
start satellite geolocation, if an environmental change is determined which relates to the end of roaming, and compare the position that has been obtained with cartographic data of areas associated with authorized communication; and
restart indirect geolocation if there is a match.

According to an embodiment of the invention, the method also includes the following steps:
start satellite geolocation, if an environmental change is determined which relates to the end of roaming;
compare the position that has been obtained with cartographic data of areas associated with authorized communication and those associated with restricted communication; and
restart indirect geolocation and stop satellite geolocation, if there is a match with an area associated with authorized communication.

According to another embodiment of the invention, the step of determining the current geographical position of the tracker by indirect geolocation includes the following sub-steps:
determine the position of the tracker by detecting surrounding network elements and by searching an online database referencing each geographical position associated with the detected network elements by using the communication means, the position that is then determined is entered into an online cartographic platform;
superimpose the position that has been determined on an in-built cartographic database including areas associated with restricted communication and areas associated with authorized communication;
determine the appropriate mode of operation of the tracker based on the result of the comparison of the restricted communication areas of the cartographic database and the position of the tracker; and
deactivate indirect geolocation and switch to the “offline” mode of operation if the comparison of the restricted areas of the cartographic database including areas associated with a restricted communication with the determined position of the trackers shows a match, which means that the tracker is located within an area associated with restricted communication.

In practice, the step of disabling indirect geolocation and switching to “offline” mode includes the following sub-steps:
search an online database, including all the information relating to flights in an airport, such as identifiers and locations of boarding gates, associated check-in gates, geographical airport data, destination and estimated flight time for each flight, and compare the last geographical position obtained by the communication means before movement into an area of restricted communication with the geographical airport data of the aforementioned database;
determine the flight in which the entity is roaming on the basis of the last position recorded before movement into an area of restricted communication and on the basis of the information in the online database that has been searched;
after determining the flight associated with the roaming entity, download the information relating to the flight that has been determined.

According to a particular embodiment of the method according to the invention, the step of determining an environmental change in relation to the end of roaming includes the following sub-steps:
compare the time that has elapsed since switching to offline mode and activating the satellite geolocation means with the expected theoretical duration of roaming, calculated from the data downloaded before activating offline mode;
prevent the activation of the satellite geolocation means and keep the device in offline mode, if the time that has elapsed since activating offline mode is less than the expected theoretical time;
allow the activation of the satellite geolocation means, if the time that has elapsed since going into offline mode is consistent with the expected theoretical time.

In practice, an area associated with restricted or prohibited communication occurs in areas such as airport runways, restricted areas in hospitals, restricted areas at ports or custom areas, military and private restricted areas as well as certain areas without close-range communication networks such as the open sea.

For example, the roaming mode of the entity occurs when in aircrafts, ships, trains and land vehicles.

In practice, the device may be of a kind suitable for smartphones, tablet computers, microcomputers, laptop computers, and which are able to implement the method in accordance with the invention.

The invention also concerns a computer program including instructions which, when the program is carried out by a device in accordance with the invention, enable the device to implement the steps of the method according to the invention.

Thus, the tracker, in accordance with the invention, is compact, easy to use, inexpensive to build, energy optimized and reliable while respecting international regulations of communication restriction/prohibition, as well as dead zones of communication, which include but are not limited to, areas crossed during flights at high altitude, but also areas of open sea and isolated mountainous regions.

Further advantages and features of the invention will become apparent from the description and the drawings in which:

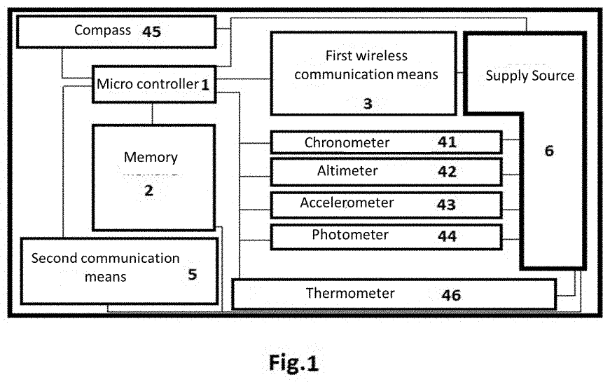

FIG. 1 schematically represents the constituent elements of an embodiment of the electronic communication device in accordance with the invention;

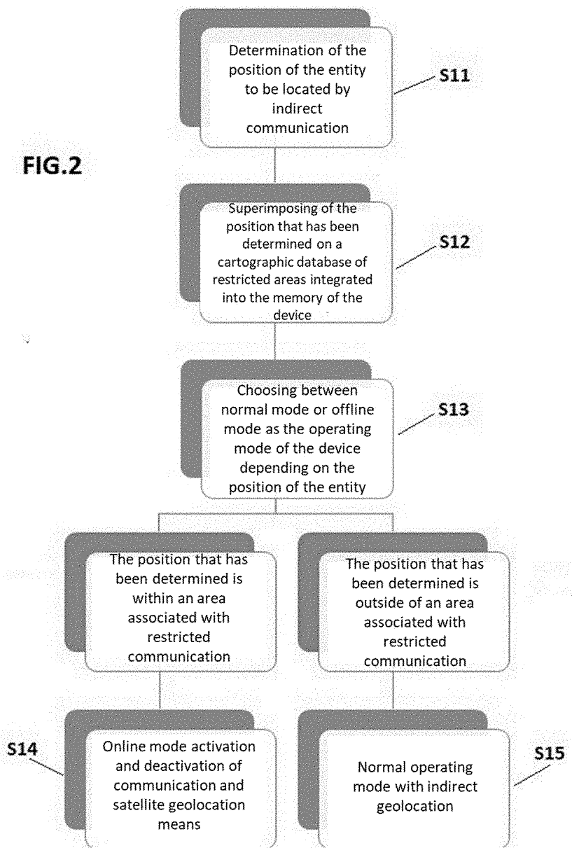

FIG. 2 illustrates the steps for determining the operating mode of the device to be adopted according to its current geographical position detected indirectly according to the invention;

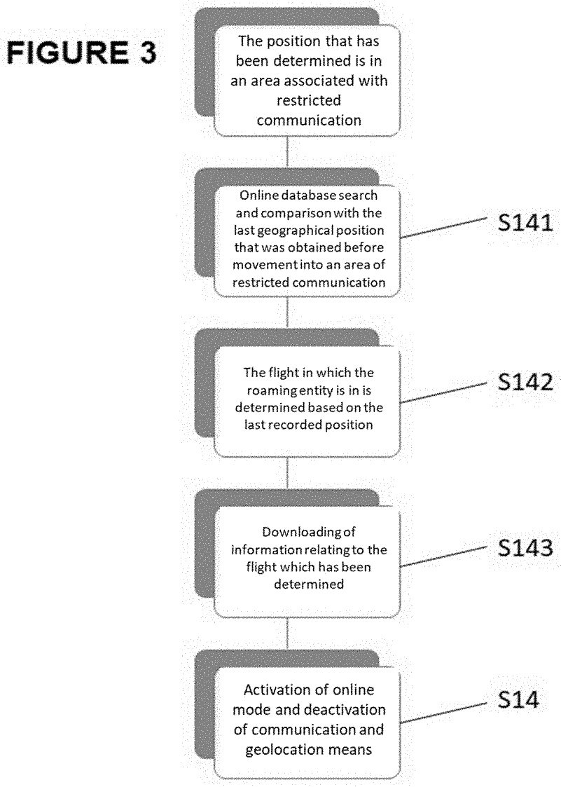

FIG. 3 illustrates the steps for retrieving roaming information before going Offline;

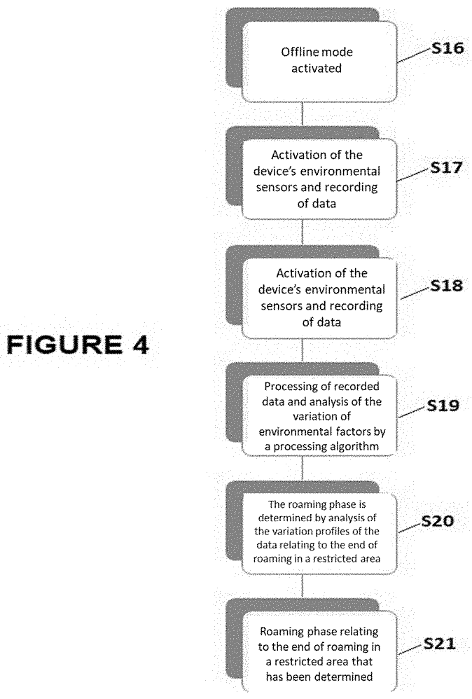

FIG. 4 illustrates the steps for detecting the end of the roaming phase within an area of restricted or prohibited communication in accordance with the invention;

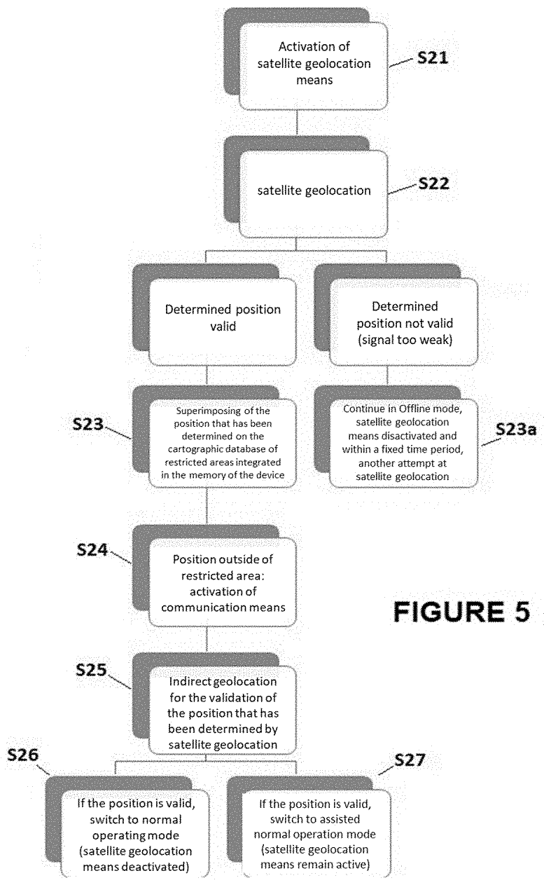

FIG. 5 illustrates the steps for locating and validating the exit out of an area associated with a restricted or forbidden communication;

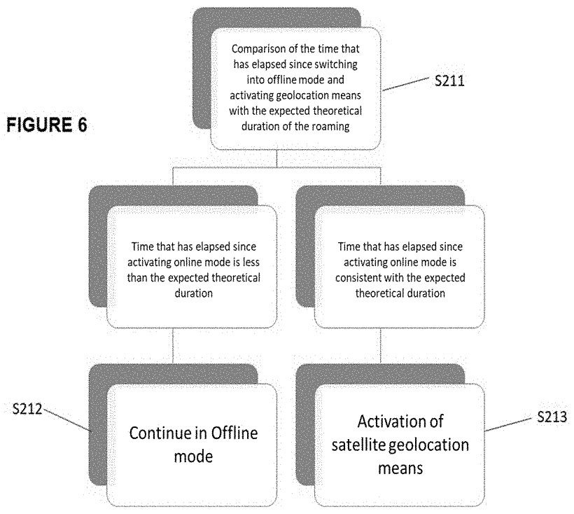

FIG. 6 illustrates the steps for checking the consistency between the activation of the satellite geolocation means and the estimated roaming time;

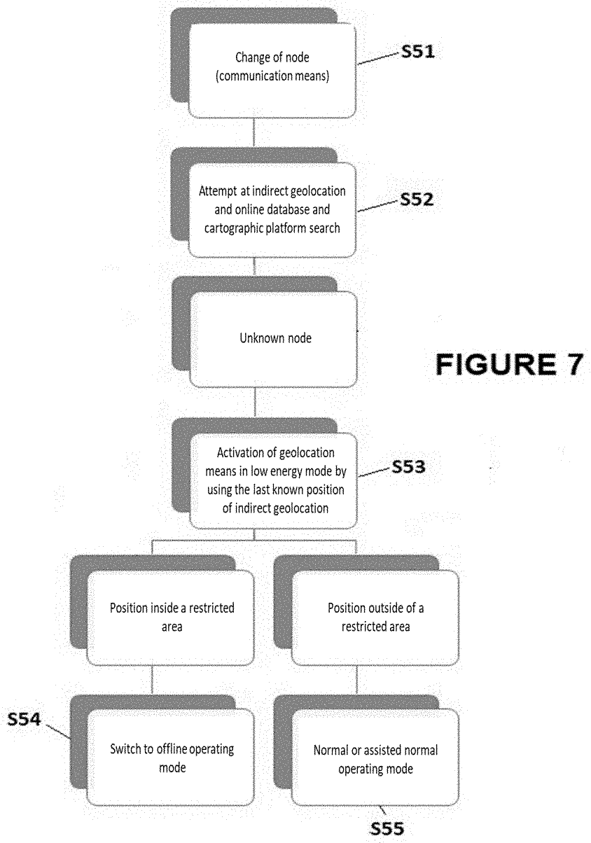

FIG. 7 illustrates the steps for detecting surrounding network elements (62) allowing indirect geolocation of the device, in accordance with the invention; and

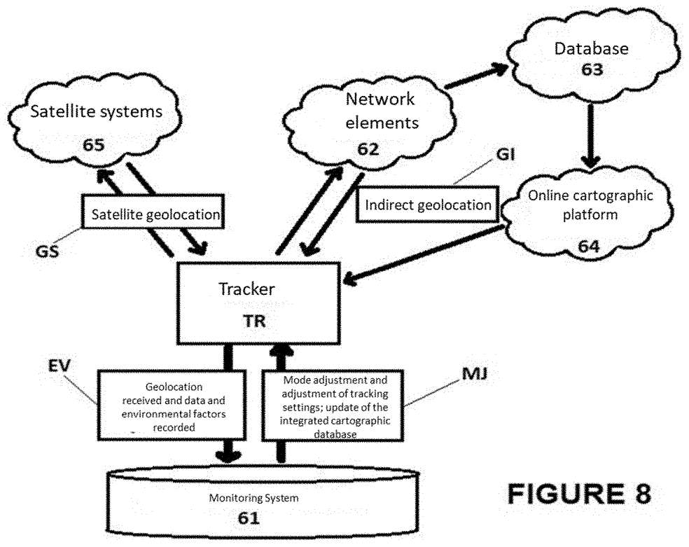

FIG. 8 represents schematically the interaction between the tracker, the monitoring system and the linked geolocation means.

With reference to [FIG. 1] and [FIG. 8], the electronic communication device, according to the invention, includes communication means (3) able to detect surrounding network elements (62) and to establish a connection to a communication network, preferably a wireless one.

The communication means (3) are able to detect and identify the network elements (62) surrounding the tracker (TR), and are then able to search an online database (63) referencing the technical characteristics of each network element (62) as well as their associated geographical position. The coordinates that are then obtained by searching the online database (63) are then transferred to an online cartographic platform (64), thus making possible an indirect geolocation of the tracker (TR) by using the communication means (3).

In this patent, network element (62), refers to any communication tool which allows access to a wireless network, belonging, amongst others, to the group formed by a wireless access terminal and a mobile telephone relay antenna. The combination of at least two of these elements constitutes a network node capable of being detected by the device (TR) in accordance with the invention.

For example, the detectable network elements (62) may be, but are not limited to, BTLE, GSM, NB-IoT, 3G, 4G, 5G, Bluetooth and Wi-Fi network elements, and allow the device to carry out so-called indirect geolocation.

The online database that is searched, referencing the network elements (62), may be, but is not limited to, a “Geolocation API” database, in particular, offered by Google™.

The electronic communication device (TR) also includes satellite geolocation means (5) able to establish satellite communication with satellite systems (65) and to ensure, when in active mode, a direct satellite communication of the geolocation of the device (TR) in accordance with the invention.

The geolocation means (5) may be, but are not limited to, GPS, GLONASS, Galileo, or Compass geolocation means.

The electronic communication device (TR), according to the invention, also includes a processing unit (1), linked to an integrated memory (2) which includes a database grouping together cartographic data of areas associated with restricted and authorized communication at airports.

Thus, the memory (2) is on board the communication device (TR) allowing access to cartographic data of areas of restricted or authorized communication at airports without using the first communication means (3).

The cartographic data integrated in the memory (2) is updated by any means, including by but not limited to, a monitoring system (61) which interacts with the device (TR) via communication means (3), which makes it possible to guarantee the accuracy and reliability of the integrated cartographic data and, thus, to take into account any new addition and/or modification made to areas associated with restricted communication, in particular those associated with airports.

For example, these areas of restricted and authorized communication correspond to different areas of an airport.

The cartographic data integrated in the memory (2) of the device may also include, but is not limited to, areas associated with restricted communication that exist in hospitals, ports or customs areas, military areas, private restricted areas as well as areas associated with authorized communication which surround areas associated with restricted communication.

The processing unit (1), in accordance with the invention, is able to compare the current geographical position obtained by the communication means (3) of the device (TR), with the cartographic data of areas associated with restricted communication and areas associated with authorized communication that are integrated in the memory (2). In the event that there is a match with an area of restricted communication, the processing unit (1) is able to deactivate the communication means (3) as well as the satellite geolocation means (5), and, therefore, to switch the device (TR), in accordance with the invention, from so-called “normal” operating mode to so-called “offline” operating mode.

According to a particular embodiment, the processing unit (1), according to the invention, is able to search an online database which includes all the information relating to flights at an airport, as well as a large amount of associated information.

By way of non-limiting example, the flight information consists of the identifiers and locations of the boarding gates, associated check-in gates, and other geographic airport data, the destination and the estimated flight time for each flight.

The processing unit (1) is also able to compare the last geographical position obtained by the communication means (3) before movement into a restricted area with the geographical airport data in the database.

The result of this comparison allows the flight in which the entity is roaming to be determined from the last recorded position and the information from the online database that has been searched, by identifying the geolocation associated with a particular gate or any other geographical feature associated with a flight corresponding to the last recorded geographical position before the entity moved into a restricted area.

The processing unit (1) is able, after having determined the flight associated with the entity, to download information, including but not limited to, information relating to the flight that has been determined, such as the destination, the estimated flight duration and the departure and arrival times.

The electronic communication device (TR) also includes at least one group of sensor means (4), making it possible to measure the variations of predefined environmental factors, to record these measurements, and, thus, to track any change in the environment of the device (TR).

By way of a non-limiting example, the sensor means (4) may be in the form of a chronometer (41), an altimeter (42), an accelerometer (43), a photometer (44), a compass (45), and a thermometer (46).

The processing unit (1) is then able to method the data recorded by the sensor means (4), so as to compare the variations of each environmental factor of the electronic device (TR) that have been recorded with predefined profiles related to the end of roaming in an area associated with restricted communication.

For example, for an area associated with restricted communication such as an airplane route, for which the device (TR) must deactivate all communication between take-off and landing, the runways in airports are therefore considered, in this document, as restricted areas, in which the device (TR), in accordance with the invention, must adopt a mode of operation without communication and therefore without geolocation.

The processing unit (1) is also able to recognize a match with a profile of environmental change of the aforementioned device (TR), which may be linked to the end of roaming in an area associated with restricted communication, and is able to activate the geolocation means (5) in order to receive the satellite geographical position of the linked entity and to compare it with the cartographic data of areas of authorized communication, and, if the comparison reveals a match, to reactivate the communication means (3).

According to a particular embodiment, in accordance with the invention, the processing unit (1) is also able to compare the time that has elapsed since switching to offline mode and activating the satellite geolocation means (5), and the expected theoretical duration of roaming, calculated from the data downloaded before activating offline mode.

For example, the estimated theoretical duration can be based on the departure and arrival times of roaming.

In practice, if the time that has elapsed since going offline is less than the expected theoretical duration, it is planned that the activation of the satellite geolocation means (5) will be prevented and the device will be kept in offline mode.

If the time that has elapsed since going offline is consistent with the expected theoretical time, it is planned that the activation of the satellite geolocation means (5) will be permitted.

According to an alternative embodiment of the invention, the processing unit (1) is able to reactivate the communication means (3) while not deactivating the geolocation means (5), in the event that there is a match between the cartographic data of areas associated with a restricted communication and the determined satellite position, allowing a so-called “assisted normal” mode of operation.

The device (TR), in accordance with the invention, also includes a supply source (6) which is able to supply the components of the device.

Thanks to the low power consumption of the device, the battery does not need to have high capacity for the tracker to function at an optimal level with satisfactory autonomy.

With reference to FIGS. 2 to 7, these figures show the steps of the communication method implemented by the device (TR), in accordance with the invention.

In general, the method includes the following steps:
obtain the current geographical position of the aforementioned device (TR) by indirect geolocation;
compare the current geographical position that has been obtained with cartographic data of areas associated with restricted communication,
if there is a match, stop the communication;
measure and record at least one environmental factor of the device (TR) in order to determine an environmental change relating to the end of roaming within a restricted communication area;
if an environmental change is determined relating to the end of roaming, activate satellite geolocation and compare the resulting position with on board cartographic data of areas associated with authorized communication; and
in case of a match, reactivate the communication.

With reference to [FIG. 2], according to the first sub-step S11, the geographical position of the device (TR) is determined by indirect geolocation using the first communication means (3), the position of the device being determined by detection of surrounding network element node(s) (62) by the device (TR) and searching an online database (63) referencing network elements (62) as well as certain physical factors of these elements (62), to which a particular geographical position is inked. This search is carried out via communication means (3) and the position that is determined is then reported on an online cartographic platform (64), making it possible to obtain a determined geolocation of the entity that the tracker (TR) is linked to.

According to sub-step S12, the final position that has been obtained is superimposed on an in-built cartographic database which includes areas associated with restricted communication and areas associated with authorized communication, in order to determine whether the appropriate operating mode of the device (TR) is in a normal operating mode or offline operating mode.

As an example, the cartographic data of an airport is integrated, which includes zones associated with authorized communication such as boarding terminals, but also zones associated with restricted communication such as runways, civil communications being prohibited during the corresponding air movements, these zones are thus associated with restricted communication. If the position obtained is the position of runway, the device is then on an area associated with restricted communication and must therefore change its operating mode in order to stop all communication.

According to sub-step S13, the appropriate operating mode of the device is determined depending on the result of the comparison between areas associated with restricted communication of the cartographic database and the determined position.

If the comparison between the areas on the cartographic database associated with restricted communication and the determined position reveals that there is no match, the determined position is therefore located outside of an area associated with restricted communication, then the appropriate mode of operation remains in a normal operating mode according to sub-step S15, meaning indirect geolocation of the device (TR) with the aid of the communication means (3) is permitted.

If the comparison between the areas on the cartographic database associated with restricted communication and the determined position reveals a match, the operating mode of the device (TR) is changed according to sub-step S16 so as to operate without communication, in so-called “off-line” mode.

According to sub-step S14, communication is deactivated, this deactivation being carried out by stopping the indirect geolocation linked to the deactivation of the communication means (3) by the processing unit (1) which also deactivates the satellite geolocation by deactivating the satellite geolocation means (5). The offline mode is therefore activated.

According to an embodiment of the invention, sub-step S14 of the method, in accordance with the invention, includes sub-step S141 consisting of searching an online database which contains all the information relating to flights in an airport, as well as much associated information.

As a non-limiting example, the flight information consists of the identifiers and locations of the boarding gates, the associated check-in gates, the destination and similar geographical airport data, as well as the estimated flight time for each flight.

Step S141 also includes the comparison of the last geographical position obtained by the communication means (3) before movement into a restricted area with the geographical airport data of the aforementioned database.

Furthermore, sub-step S14 of the method, in accordance with the invention, includes sub-step S142: determining the flight in which the entity is roaming based on the last recorded position and the positions of the online database information that has been searched, by identifying the geolocation associated with a particular gate or any other geographical feature associated with a flight corresponding to the last recorded geographical position before movement into an area of restricted communication.

Finally, sub-step S14 of the method, in accordance with the invention, includes sub-step S143: downloading information relating to the flight that has been determined, such as the destination, the estimated flight time and the departure and arrival times.

When the device (TR) is in offline mode, a step determining the end of roaming in area associated with restricted communication is carried out, which includes a first sub-step S17 consisting of measuring and recording the variations of the predefined environmental factors of the device (TR) with the help of the environmental sensors (4) in order to detect the end of roaming in an area associated with restricted communication.

The data that is obtained concerning the variations in measurements of the predefined environmental factors of the device (TR) are then processed according to sub-step S18, with the aid of an algorithm making it possible to compare the variations in the predefined factors with variation profiles which may be associated with the end of roaming of the device (TR) within a zone of restricted communication.

As a non-limiting example, a profile demonstrating a variation in factors including a sudden increase in temperature beyond a defined value, as well as an increase in pressure from a low value to a second value corresponding to atmospheric pressure, i.e. 1 Bar, during air transport, is a profile which can be associated with the end of roaming in an area associated with restricted communication, revealing the end of a flight.

According to sub-steps S19 and then S20, a match between the measured variations in factors and a profile of factors that can be linked to the phase of ending roaming within a zone associated with restricted communication is determined, which starts the activation of satellite geolocation according to sub-step S21 which is carried out by the activation of the geolocation means (5) of the device (TR).

According to a first particular embodiment of the invention, step S21: activating the satellite geolocation means includes sub-step S211: comparing the time that has elapsed since switching to the offline mode and activating the satellite geolocation means (5), and the expected theoretical duration of roaming, calculated from the data downloaded during sub-step S211.

For example, the estimated duration can be based on the departure and arrival times of roaming.

According to sub-step S212 of step S21, if the time that has elapsed since going offline is less than the expected theoretical time, it is planned that the activation of the satellite geolocation means (5) will be prevented and the device will be kept in offline mode.

According to sub-step S213 of step S21, if the time that has elapsed since going offline is consistent with the expected theoretical time, it is planned that the activation of the satellite geolocation means will be enabled and step S22 will be possible.

Once satellite geolocation has been activated, a step is carried out to validate the end of roaming within the area associated with restricted communication that has been determined, which comprises a first sub-step S22 consisting of determining the geographical position of the device (TR) by using only the geolocation means (5).

If the position is said to be invalid or not determinable, as the satellite signal may not be strong enough, then, according to sub-step S23a, the satellite geolocation is deactivated and the device (TR) is returned to offline operating mode, and after a set time, a new attempt is made at satellite geolocation following the reactivation of the satellite geolocation.

If the satellite position is determined, and thus valid, then, according to sub-step S23, the obtained satellite position is superimposed on a cartographic database of areas of restricted and unrestricted communication integrated in the memory (2) in order to confirm the end of the roaming of the device (TR) within an area of restricted communication.

Finally, if the position determined by satellite geolocation is outside the area associated with restricted communication, then, according to sub-step S24, the indirect geolocation is reactivated by reactivating the communication means (3).

According to a first mode of embodiment of the invention, the reactivation of the indirect geolocation is accompanied, according to sub-step S26, by the deactivation of the satellite geolocation and therefore of the geolocation means (5), thus allowing the device (TR) to switch to so-called normal operating mode.

According to an alternative mode of embodiment of the invention, the reactivation of the indirect geolocation is accompanied, according to sub-step S27, by the continuation of the operation of satellite geolocation and therefore of the satellite geolocation means (5), thus allowing the device (TR) to switch to so-called assisted normal operating mode, and making possible greater accuracy and reliability of the geolocation.

During sub-step S11 of the method, in accordance with the invention, and in order to determine the position of the device (TR) by detecting at least two network elements (62), the network node that has been detected may not be referenced in the online database that will be searched (63) and therefore includes several sub-steps allowing to guarantee a reliable indirect geolocation in accordance with the communication restrictions associated with certain areas.

According to sub-steps S51 and S52, in the event of a change of network node, an indirect geolocation is carried out followed by searching the online database (63) allowing a node that has been detected to be linked to a geographical position.

If the new node is unknown, then satellite geolocation is activated by activating the satellite geolocation means (5), which, according to sub-step 53, carry out a so-called “low energy” geolocation using the last known position in indirect geolocation, the position that has been determined being then sent to the online database (63) in order to link the unknown node to a given geographical position.

Finally, if the newly determined position is in an area associated with restricted communication, then all geolocation and associated means are deactivated, and the device (TR) goes into offline operation mode according to sub-step S54.

If, on the other hand, the new position that has determined is not in an area associated with restricted communication, then the device (TR) continues in its normal or assisted normal operating mode depending on the geolocation mode defined by the user.

It should be noted that the roaming entity may move through areas where satellite geolocation is damaged or even unavailable, hence the need to obtain reliable indirect geolocation using the communication means (3), this mode of geolocation being more energy efficient for the device (TR), and allowing for more accurate geolocation when the device (TR) is located indoors, which could potentially damage/prevent the establishment of satellite geolocation.

The method thus described may be implemented by computer, in the form of a computer program consisting of instructions which cause the device, according to the invention, to carry out the steps of the method in accordance with the invention.

With reference to [FIG. 6], the monitoring system (61), in accordance with the invention, fulfils an initial role as data receiver (EV). This data includes the indirect geolocation (GI) determined by the communication means (3) and the direct satellite geolocation means (GS) of the device (TR), this direct geolocation (GS) or indirect geolocation (GI) is transmitted using the communication means (3). The monitoring system (61) also receives the environmental data recorded by the tracker (TR).

The monitoring system (61) then carries out a second role which consists of transmitting data (MJ) to the device (TR), this data may include but is not limited to: updates to the cartographic database integrated in the device (TR) and including the areas associated with restricted communication and authorized communication, but also instructions concerning the device's (TR) tracking mode.

The monitoring system (61) can therefore alter, amongst others, the delay, or the frequency at which the geolocation that has been determined by the device (TR) is sent so that it is adapted to the route of the entity to which the device is linked.

The alteration of the delay or frequency of transmission of the geolocation that has been determined by the tracker (TR) also makes it possible to optimize the energy consumption of the aforementioned tracker (TR) based on the route of the linked entity.

Thus, the monitoring system (61) has at its disposal the geographical position of the entity during the whole of its route while respecting the regulations concerning zones associated with restricted or even prohibited communication.

According to a particular embodiment of the invention, the described method may be implemented by any communication device including: a processing unit (1), a memory (2), communication means (3), at least one satellite geolocation tool (5), and components able to carry out the function of environmental sensor means (4).

The method, in accordance with the invention, may therefore be implemented in, devices including but not limited to those belonging to the group formed by smartphones, tablet computers, microcomputers, and laptop computers. (to be completed)

In practice, in the case of a smartphone, the components listed above are integrated into the device. Thus, in online mode the smartphone transmits its geolocation, and can automatically switch to offline mode when it is geolocated in an area associated with restricted communication, in accordance with the invention, and can reactivate the communication of its geolocation upon detection of any exit out of an area associated with restricted communication in a manner similar to the tracker (TR), in accordance with the invention.

The communication device, according to the invention, is configured to allow the implementation of the method thus described.

1-15. (canceled)

16. An electronic communication tracking (TR) device to be linked to a roaming entity, comprising:
a processing unit;
a data memory comprising cartographic data of areas associated with restricted communication and cartographic data of areas associated with authorized communication;
communication circuitry to provide, when in active mode, indirect geolocation of the tracker (TR) by detection of network elements and searching an online database including the location of the network elements, and transmission of the geolocation to a monitoring system of the roaming entity;
sensor circuitry to continuously sense at least one of the tracker's (TR) environmental factors in order to indicate an environmental change around the tracker (TR) which relates to the end of the entity's roaming within an area of restricted communication; and
satellite geolocation circuitry for providing, when in active mode, direct geolocation communication in order to sense a satellite geographical position; wherein the processing unit is also to compare the current geographical position that has been obtained by indirect geolocation with cartographic data of areas associated with restricted communication, and in the event of a match, the processing unit to deactivate the communication circuitry and the satellite geolocation circuitry; and the processing unit is further to, after having determined an environmental change of the aforementioned tracker which relates to the end of roaming, activate the geolocation satellite circuitry to obtain the satellite geographic position of the tracker (TR) and to compare it with the cartographic data of areas with authorized communication, and if the comparison reveals a match, to reactivate the communication circuitry for an indirect geolocation of the aforementioned tracker (TR).

17. The electronic communication device of claim 16, wherein the processing unit, after it has been determined that the entity has ceased roaming within a restricted communication area, is to activate the satellite geolocation circuitry to obtain the satellite geographical position of the device (TR) and to compare it with the data for areas of authorized communication, and if there is a match, to reactivate the communication circuitry and deactivate the satellite geolocation circuitry.

18. The electronic communication device of claim 16, wherein the communication circuitry to detect network elements distributed within areas authorized communication and to search an online database to indirectly obtain the geolocation linked to the connected elements that have been detected, and to report the positions that are then determined on an online cartographic platform in order to obtain the current geographical position of the tracker (TR) by indirect geolocation.

19. The electronic communication device of claim 16, wherein the sensor circuitry includes one or more from the group of a chronometer, an altimeter, an accelerometer a photometer, a compass, and/or a thermometer.

20. The electronic communication device of claim 16, wherein the processing unit is further to:
search an online database, including information relating to flights in an airport, such as identifiers and locations of boarding gates, associated check-in gates, geographical airport data, destination, estimated flight time for each flight;
compare the last geographical position obtained by the communication circuitry before movement into an area of restricted communication with the geographical airport data in the database;
determine the flight in which the entity is roaming on the basis of the last position recorded before moving into an area of restricted communication and on the basis of the information in the online database that has been searched; and
after determining the flight linked to the roaming entity, download the information relating to the flight that has been determined.

21. The electronic communication device of claim 20, wherein the processing unit is further to:
compare the time that has elapsed since switching to offline mode and activating the satellite geolocation circuitry and the expected theoretical duration of roaming, calculated from the data downloaded before activating offline mode; and
prevent the activation of the satellite geolocation circuitry, if the time that has elapsed since activating offline mode is less than the expected theoretical duration.

22. The electronic communication device of claim 20, wherein the processing unit is further to:
compare the time that has elapsed since switching to offline mode and activating the satellite geolocation means with the expected theoretical duration of roaming, calculated from the data downloaded before activating offline mode; and
enable activation of the satellite geolocation circuitry, if the time that has elapsed since going offline is consistent with the expected theoretical duration.

23. A method of communication between a monitoring system monitoring a roaming entity and an electronic communication tracking (TR) device linked to the roaming entity, comprising:
obtaining the current geographical position of the tracker (TR) by indirect geolocation by detecting surrounding network elements and searching an online database referencing each geographical position linked to the network elements detected via communication means and transmitting this to the monitoring system;
comparing the current geographical position that has been obtained with cartographic data of areas associated with restricted communication,
in the event of a match, stop the indirect geolocation;
measuring and record at least one of the tracker's (TR) environmental factors in order to determine an environmental change which relates to the end of roaming within the area of restricted communication;
start satellite geolocation, if an environmental change is determined which relates to the end of roaming, and compare the position that has been obtained with cartographic data of areas associated with authorized communication; and
in the event of a match, restart the indirect geolocation.

24. The method of claim 23, further comprising:
starting satellite geolocation if an environmental change which relates to the end of roaming has been determined; and
comparing the obtained position with cartographic data of areas associated with authorized communication; and
if there is a match, restart indirect geolocation and stop satellite geolocation.

25. The method of claim 23, further comprising:
determining the position of the tracker (TR) by detecting surrounding network elements and searching an online database referencing each geographical position linked to the network elements that have been detected via communication means, the position that has been determined is then recorded on an online cartographic platform;
superimposing the position that has been determined on an on board cartographic database including areas associated with restricted communication and areas associated with authorized communication;
determining the appropriate operating mode of the tracker (TR) depending on the result of the comparison between the areas associated with restricted communication on the cartographic database and the determined position; and
deactivating the indirect geolocation and switch to “offline” operating mode if the comparison between the restricted areas on the cartographic database including areas associated with restricted communication and the determined position reveals a match, which means that the location of the tracker (TR) is within one of the areas associated with restricted communication.

26. The method of claim 25, wherein deactivating the indirect geolocation and switching to the “offline” operating mode further comprising:
searching an online database, including all the information relating to flights in an airport, such as identifiers and locations of boarding gates, associated check-in gates, geographical airport data, destination and estimated flight time for each flight, and compare the last geographical position obtained by the communication means before movement into an area of restricted communication with the geographical airport data of the database;
determining the flight in which the entity is roaming from the last position retained before movement into an area of restricted communication and from the information in the online database that was searched; and
after having determined the flight associated with the roaming entity, download the information relating to the flight that has been determined.

27. The method of claim 26, wherein determining an environmental change relating to the end of roaming further comprising:
comparing the time that has elapsed since switching to offline mode and since activating the satellite geolocation means and the expected theoretical duration for roaming, calculated from the data downloaded before activating offline mode;
preventing the activation of the satellite geolocation means and keep the device in offline mode if the time that has elapsed since activating offline mode is less than the expected theoretical duration; and
enabling activation of the satellite geolocation means, if the time that has elapsed since going offline is consistent with the expected theoretical duration.

28. The method of claim 22, wherein the area associated with restricted or prohibited communication occurs in areas such as airport runways, hospital restricted areas, port or customs restricted areas, military areas and private restricted areas, and areas without close-range communication networks such as the open sea.

29. The method of claim 22, wherein the roaming mode of the entity occurs when in aircrafts, ships, trains and land vehicles.
